(19) United States
(12) Patent Application Publication
(10) Pub. No.: US 2002/0090440 A1
(43) Pub. Date: Jul. 11, 2002

(54) Maharaja dressing/indian dressing

(76) Inventors: Sajid Ali M. Khan, Ridgefield Park, NJ (US); Adil Ali Khan, Ridgefield Park, NJ (US)

Correspondence Address: SAJID ALI MIRZA KHAN, 2 UNION PLACE, RIDGEFIELD PARK, NJ, 07660, US

(21) Appl. No.: 09/754,977

(22) Filed: Jan. 5, 2001

(51) Int. Cl. A23L 1/24

(52) U.S. Cl. 426/605

(57) ABSTRACT

Two new salad dressings with new and exotic flavors.

### SPECIFICATION

Just like salad dressings from Russia, France, Italy etc. I would like to patent two salad dressings from India: (a) Maharaja dressing and (b) Indian dressing.

(A) Maharaja dressing will consist of the following ingredients: soybean oil, water, Vinegar, sugar, egg yolks, salt, spices, sour cream powder, xanthum gum, dry garlic, Polysorbate 60, Calcium Disodium Edta as preservatives.

(B)Indian dressing will consist of: corn syrup, soybean oil, water, tomato paste, vinegar, sugar, salt, heavy cream powder, lemon juice, roasted garlic powder, xanthum gum, dried onion powder, Potasium sorbate, spices, calcium sorbate, and paparika

We have Americanized our Indian dressings to appeal to the taste of Americans. The two salad dressings we would like to patent will add to the wide variety already available. They will give a mild taste of Indian curry. They will be good for salad dressings as well as marinades.

### BACKGROUND OF INVENTION

Most Indian restaurants and grocery stores continue to offer Indian marinades catering to the Indian taste. We would to introduce American standards and taste to the salad dressings.

### BRIEF SUMMARY OF THE INVENTION

Maharaja dressing and Indian dressing will add Indian curry flavor without being to spicy and pungent for the American taste.

What we claim as our inventions are:

1. Maharaja dressing and Indian dressing both having curry ingredients mixed with American standard ingredients to create two new flavors.
